(19) United States
(12) Patent Application Publication
(10) Pub. No.: US 2007/0071395 A1
(43) Pub. Date: Mar. 29, 2007

(54) DIGITAL CAMCORDER DESIGN AND METHOD FOR CAPTURING HISTORICAL SCENE DATA

(76) Inventors: Jeff Boone, Sunnyvale, CA (US); Xin Wen, Palo Alto, CA (US)

Correspondence Address: Xin Wen, 3449 Rambow Drive, Palo Alto, CA, 94306, US

(21) Appl. No.: 11/530,456

(22) Filed: Sep. 8, 2006

Related U.S. Application Data
(60) Provisional application No. 60/721,111, filed on Sep. 28, 2005.
(60) Provisional application No. 60/721,112, filed on Sep. 28, 2005.

(51) Int. Cl. H04N 5/91

(52) U.S. Cl. 386/46

(57) ABSTRACT

A method for video recording includes producing a first video data by an image sensor in a video recording device, storing the first video data in a temporary memory buffer in the video recording device, selecting at least a portion of the first video data in a semi-permanent data storage, and copying the selected portion of the first video data from the temporary memory buffer to the semi-permanent data storage in the video recording device.

### CROSS REFERENCES TO RELATED APPLICATIONS

This application claims the benefit of priority under 35 U.S.C. Section 120 of the Provisional U.S. Patent Application Ser. No. 60/721,112, entitled “DIGITAL CAMCORDER DESIGN AND METHOD FOR CAPTURING HISTORICAL SCENE DATA”, filed Sep. 28, 2005 and U.S. Provisional Patent Application Ser. No. 60/721,111, titled “DIGITAL AUDIO RECORDER DESIGN AND METHOD FOR CAPTURING HISTORICAL DATA”, filed Sep. 28, 2005. The content of these patent applications is incorporated herein by reference.

### BACKGROUND

This application relates to a video or audio recording device.

Video photography is a popular way for people to capture and preserve valued memories. Video camcorders have become prolific in the consumer market space. To capture a scene of interest, a photographer turns on a camcorder and presses a button to set the camcorder to a “record” mode. The scenes are captured by an image sensor and converted to video data in the video camcorder. The video data are typically recorded on a replaceable storage device such as magnetic tape, DVD-R, CD-R, etc. The camcorder can also be set at an “Idle mode” in which no scene images are being captured. One drawback with current camcorders is that a photographer often misses a scene or a moment worth recording because the photographer can often not react fast enough to record a scene. Another drawback of the video recording using the current camcorders is that a photographer often has to record long periods of uninteresting scenes without knowing whether anything worthwhile will occur.

### SUMMARY

In one aspect, the present invention relates to a method for video recording. The method including producing a first video data by an image sensor in a video recording device; storing the first video data in a temporary memory buffer in the video recording device; selecting at least a portion of the first video data in a semi-permanent data storage; and copying the selected portion of the first video data from the temporary memory buffer to the semi-permanent data storage in the video recording device.

In another aspect, the present invention relates to a method for audio recording. The method includes producing a first audio data by a micro phone in an audio recording device; storing the first audio data in a temporary memory buffer in the audio recording device; selecting at least a portion of the first audio data in a semi-permanent data storage; and copying the selected portion of the first audio data from the temporary memory buffer to the semi-permanent data storage in the audio recording device.

In another aspect, the present invention relates to a video recording device including an image sensor configured to produce a first video data and a second video data; and a recording system in electronic communication with the image sensor, wherein the recording system is configured to store the first video data in a temporary memory buffer in a first video recording mode and to store the second video data in a semi-permanent data storage in a second video recording mode, wherein at least a portion of the first video data is configured to be copied from the temporary memory buffer to the semi-permanent data storage. Implementations of the system may include one or more of the following. The semi-permanent data storage can be selected from the group of a magnetic tape, a recordable disk, a hard drive, a DVD-R, and a CD-R. The temporary memory buffer can be selected from the group of random access memory (RAM), dynamic random access memory (DRAM), static random access memory (SRAM), EEPROM, and a flash memory. The method can further include writing the most recent portion of the first video data over the oldest portion of the first video data in the temporary memory buffer. The first video data can be more than the capacity of the temporary memory buffer. The step of selecting can include determining if at least a portion of the first video data is worth storing in a semi-permanent data storage, and if at least a portion of the first video data is determined to be worth storing in a semi-permanent data storage, selecting at least the portion of the first video data. The method can further include producing a second video data by the image sensor; and storing the second video data in the temporary memory buffer in the video recording device while the selected portion of the first video data is copied from the temporary memory buffer to the semi-permanent data storage in the video recording device. The method can further include producing a second video data by an image sensor in a video recording device and storing the second video data in the semi-permanent data storage without storing the second video data in the temporary memory buffer.

Implementations of the system may include one or more of the following. The semi-permanent data storage can be selected from the group of a magnetic tape, a recordable disk, a hard drive, a DVD-R, and a CD-R. The temporary memory buffer can be selected from the group of random access memory (RAM), dynamic random access memory (DRAM), static random access memory (SRAM), EEPROM, and a flash memory. At least one of the semi-permanent data storage and the temporary memory buffer can be configured to be removed from the video recording device and inserted into the video recording device such that the one of the semi-permanent data storage and the temporary memory buffer is in electronic communication with the recording system. The temporary memory buffer can include a circular buffer that allows the recording system to write the most recent portion of the first video data over the oldest portion of the first video data in the temporary memory buffer. The video recording device can further include a user interface that allows a user to select at least a portion of the first video data to be copied to the semi-permanent data storage. The temporary memory buffer can include a data pointer configured to indicate the current recording location in which the next video data is to be written in the temporary memory buffer.

The disclosed system and methods include the following advantages. The disclosed system and methods allow a photographer to not miss scenes or moments worth recording. The disclosed system and methods provide a video camcorder a novel “temporary recording mode” in addition to the conventional “idle mode” and “record mode”. The “temporary recording mode” allows scenes to be continually recorded in a temporary memory buffer without storing the video data in semi-permanent data storage on the camcorder. The disclosed system and methods allow historical scenes captured in the “temporary recording mode” to be reviewed by the photographer. The photographer can make decision after the recording of the scenes whether the recorded video data is worth storing on the semi-permanent data storage such as a magnetic tape, DVD-R, CD-R. Only noteworthy scenes can be selectively recorded in the semi-permanent data storage while uninteresting scenes can be discarded. The disclosed system and methods allow interesting scenes to be recorded without filling up the memories in the video recording system with uninteresting video data. The disclosed system and methods are compatible with a variety of digital camcorders including those that use the MiniDV format as well as HD camcorders that use MPEG-2 or MPEG-4 compression.

The disclosed system and methods also provides an improved audio recording device that can continually record audio signals on a temporary memory buffer in a temporary recording mode. After an audio signal has been recorded, the user can decide the save the temporarily recorded audio signal in the semi-permanent data storage on the audio recording device. The disclosed system and methods allow a user to save historically recorded and audio signals without unnecessarily recording too much uninteresting audio data and filling up the memories in the audio device.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 is a block diagram of the video recording device in accordance with the present specification.

FIG. 2 illustrates a process for capturing a historically captured scene data using the video recording device of FIG. 1.

FIGS. 3A illustrate an arrangement of data structure compatible with the video recording device of FIG. 1.

FIGS. 3B illustrate a data copying process from the temporary memory buffer to the semi-permanent data storage in the video recording device of FIG. 1.

FIG. 4 is a block diagram of the audio recording device in accordance with the present specification.

FIG. 5 illustrates a process for capturing a historically captured audio data using the audio recording device of FIG. 4.

### DETAILED DESCRIPTION

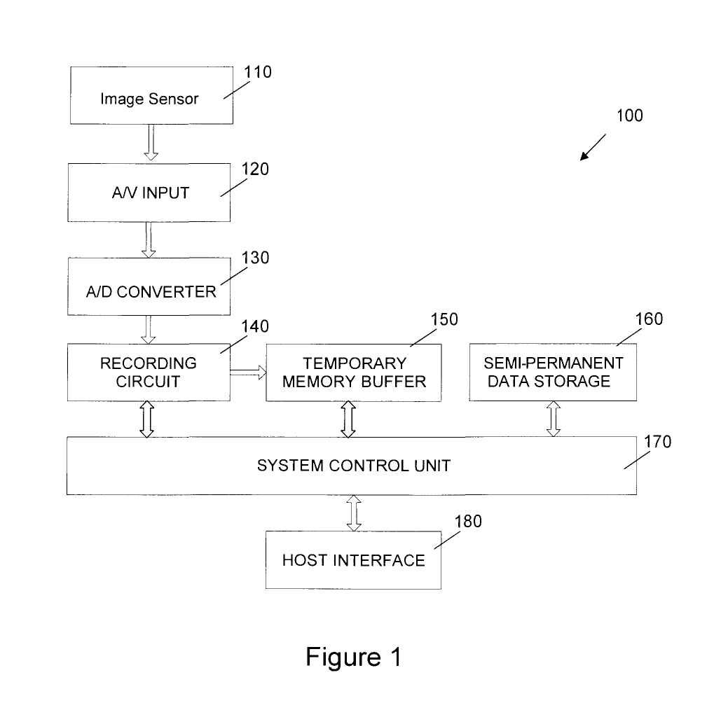

FIG. 1 illustrates a video recording device 100. Examples of the video recording device 100 include digital or analog camcorders. The video recording device 100 can include an image sensor 10 that can be based on CCD, CMOS, or other types of sensors. The image sensor 110 can include sensors for capturing light in different spectral ranges such as red, green, blue, infrared, or UV. The video recording device 100 can include an optical system that can project a scene to form an image at the image sensor 110. The video recording device 100 can include an A/V input circuit 120 that receives and processes the analog video signal from the image sensor 110 and an Analog-to-Digital (A/D) converter 130 that can convert the analog video signals to digital video signals. The video signals can include image signals and audio signals. The digital video signals can be represented in a series of image frames that correspond to a series of captured scenes. The video recording device 100 can further include an image processor that can conduct image processing operations as color plane construction from the color filter array, tone calibration, color calibration, noise compensation, image correction, image compression, and transformation to a specified video standard, etc. The image processing operations can be specified by predetermined criteria set by the manufacturer or by the user of the video recording device 100.

The video signal (in digital or analog format) can be transferred to a recording circuit 140 that is in electronic communications with a temporary memory buffer 150 and a semi-permanent data storage 160 via a system control unit 170.

The temporary memory buffer 150 and the semi-permanent data storage 160 can be detached and replaced. Examples of the temporary memory buffer 150 include a random access memory (RAM), dynamic random access memory (DRAM), static random access memory (SRAM), electrically erasable programmable read-only memory (EEPROM) such as a flash memory, and so on. Examples of the semi-permanent data storage 160 can include magnetic tape for digital or analog recording format (e.g. Mini-DV magnetic tape, Digital 8 mm magnetic tape, Hi-8 mm magnetic tape, or 8 mm magnetic tape, etc.), DVD-R, CD-R, hard drives, etc.

In some embodiments, the temporary memory buffer 150 can be overwritten by data many times. The data stored in the temporary memory buffer 150 does not need to retain its contents when the video recording device 100 is powered “off”. The semi-permanent data storage 160 can store digital data that can retain its content either the video recording device 100 is powered “on” or “off”.

The recording circuit 140 can include a recording head that is compatible with the type of semi-permanent data storage 160 such as magnetic tape, DVD-R, CD-R, hard drives. For example, the recording head can include a magnetic head for writing data on a magnetic tape or on a hard drive. The recording head can also include a laser head for writing data on a DVD-R or a CD-R disk. The video recording system 100 can also include mechanisms for receiving and holding the temporary memory buffer 150 and the semi-permanent data storage 160. The recording circuit 140 can control the writing of video data in the temporary memory buffer 150 or the semi-permanent data storage 160 in response to the video signal. The recording circuit 140 can also the read of the video data stored in temporary memory buffer 150 or the semi-permanent data storage 160. A host interface 180 in electronic communication with the system control unit 170 allows the video data stored on the temporary memory buffer 150 and the semi-permanent data storage 160 to be transmitted to external devices.

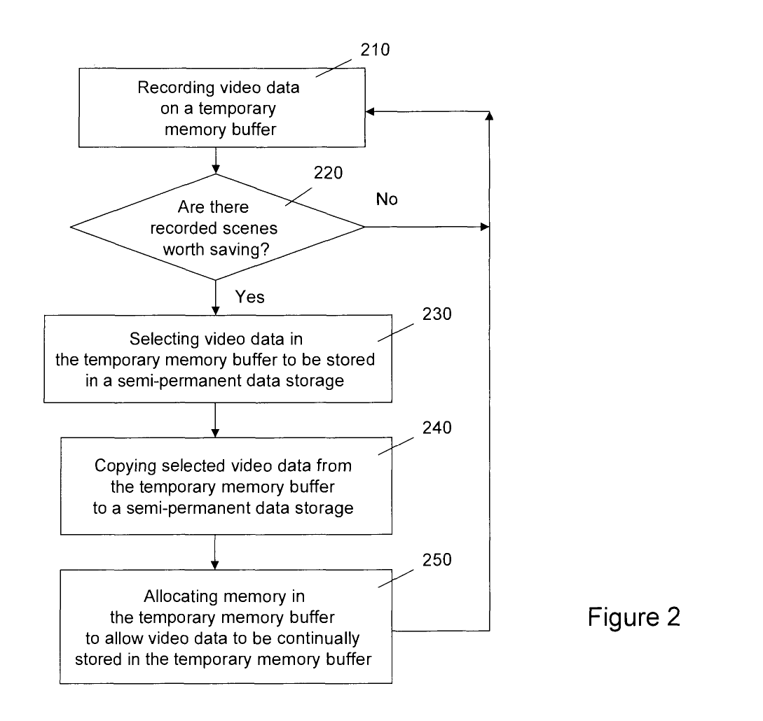

The video recording device 100 is illustrated in a flow chart in FIG. 2. After being switched on, the video recording device 100 can be automatically set to an “idle mode”. Similar to conventional camcorder devices, the video recording device 100 can include a “record mode” in which video data produced by the image sensor 110, the A/V input 120, and A/D converter 130 can be recorded directly onto the semi-permanent data storage 160. The “record mode” can be used by a photographer who is sure that the scenes are interesting and worth recording.

The video recording device 100 can also include a “temporary record mode”. The photographer can set the video recording device 100 into the “temporary record mode” by pushing a button, an icon on a touch screen, or by voice instruction using a voice recognition system. The video data produced by the image sensor 110, the A/V input 120, and A/D converter 130 is stored in the temporary memory buffer 150 (step 210). The photographer can use the “temporary record mode” when scenes are not worth recording at the moment but some interesting worth recording might occur. For example, a mother can set the video recording device 100 in the “temporary record mode” when her baby is playing at home in case the bay may produce some interesting expressions or actions that are worth recording.

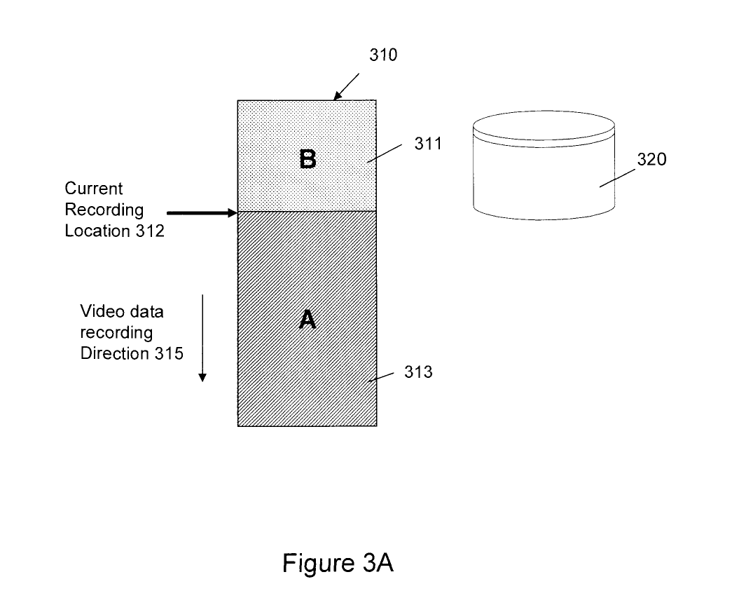

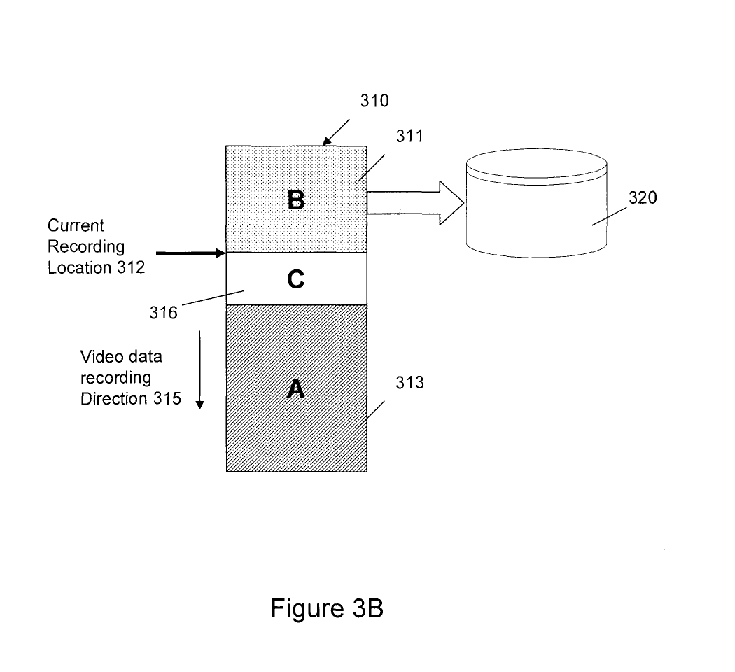

In some embodiments, an implementation the temporary memory buffer 150 is shown in FIG. 3A, the temporary memory buffer 310 can be a circular (or ring) memory buffer. The video data can be continually stored to the temporary memory buffer 310 in a sequence as denoted by a video data recording direction 315. The video data stored in the temporary memory buffer 310 can include a video data portion 311 (“B” in FIG. 3A) that includes the most recently recorded video data, and a video data portion 313 (“A” in FIG. 3A) that were oldest video data. A data pointer 312 indicates the current recording location, that is, the data location in which the next video data is to be written in the temporary memory buffer 310. In the continually recording mode, the current recording location is normally at the end of the most recent video data 311. The temporary memory buffer 310 can be substantially filled with the video data. New video data received by the temporary memory buffer 310 can be automatically written over the oldest video data portion 313. The data pointer 312 concurrently moves down to the end of the video data portion 311 to update the current recording location 312. When the bottom of the temporary memory buffer 310 is reached, the recording circuit 140 continues writing at the top of the temporary memory buffer 310.

The maximum duration of a video clip that can be stored in the temporary memory buffer 310 can be determined by at least the following two factors:

1) the size of temporary memory buffer;

2) the compression technique used on the digital audio and video data.

For example, the data rate of a standard MiniDV video format is approximately 3.6 MB/second. A temporary memory buffer 310 with 54 MB storage capacity can hold video data for 15 seconds of historical scenes. The HD digital video has data rates in the range from about 2 MB/second to about 4 MB/second depending on format and compression ratio. A temporary memory buffer 310 having a 128 MB storage capacity can hold about 30 to 60 seconds of video data in the HD digital video format. The duration of the video clip that can be stored in the temporary memory buffer 310 can be increased by using larger capacity memories in the temporary memory buffer 310.

The photographer can determine whether the video data stored in the temporary memory buffer 310 is worth saving (step 220). For example, the baby may have made an interesting sound or made a nice smile when the baby is recorded in the “temporary record mode” by a parent. The parent can decide some or all the video data in the video data portion 311 and 313 is worth saving in the semi-permanent data storage 160. The parent may select a portion of the video data in the video data portions 311 and 313 (step 230) and copy the selected video data portion to the semi-permanent data storage 160 (step 240), as shown in FIG. 3B.

The photographer may be able to preview the video data portions 311 and 313 to determine which portion of the video data is to be copied to the semi-permanent data storage 160. The video recording device 100 can also include user interface features to allow the photographer to copy the selected video data portion on the semi-permanent data storage 160.

In some embodiments, a portion 316 of the temporary memory buffer 310 can be reserved to keep recording while the selected video data is being copied from the temporary memory buffer 150 to the semi-permanent data storage 160 (step 250). New scenes can be continually captured by the image sensor 110 and stored in the temporary memory buffer 150 while the selected image data is copied. This technique can prevent “glitches” in the video data for a continuous series of image scenes.

In some embodiments, once the photographer decides that some portion of the video data stored in the temporary memory buffer 310 is worth saving, the video recording device can automatically kick into the “record mode” in which the additional video data produced by the image sensor 110, the A/V input 120, and A/D converter 130 is stored in the semi-permanent data storage 160. The copying of the selected video data can occur simultaneously or asynchronously relative to the recording of the additional video data.

In some embodiments, the selected video data is transferred to the semi-permanent data storage 160 and deleted from the temporary memory buffer 150. The freed up memory space can be immediately used for the recording of the new video data. In one implementation, the data pointer 312 for the current recoding location can also be moved to make use of the freed-up memory space.

It should be understood that the above disclosed system and methods are limited to the specific described examples. For example, the disclosed system and methods are compatible with both digital and analog video data that can be stored in the temporary memory buffer 150 and the semi-permanent data storage 160.

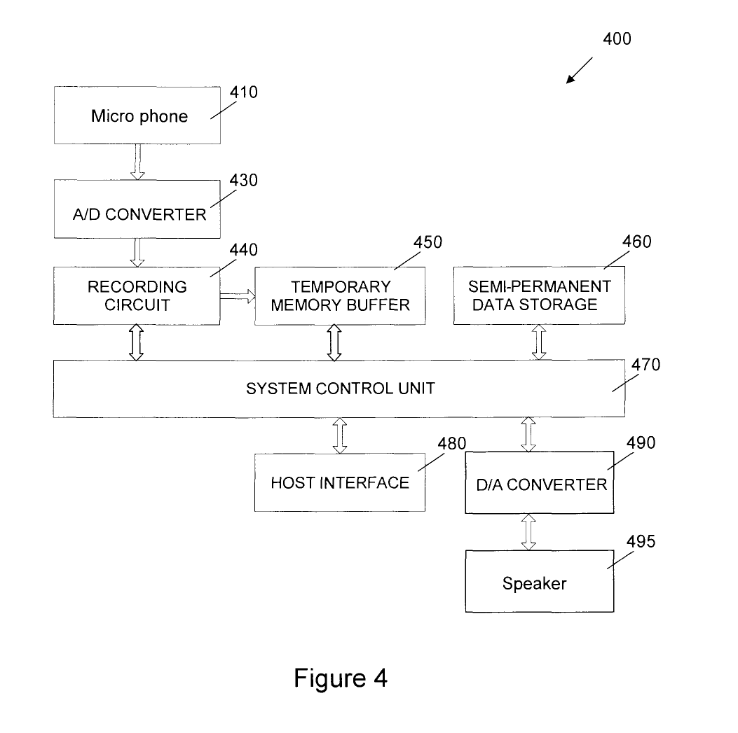

The disclosed methods and design can similarly be applied to an audio recording device. FIG. 4 illustrates an audio recording device 400. Examples of the audio recording device 400 include digital or analog camcorders. The audio recording device 400 can include a microphone 410. The audio recording device 400 can include a microphone 410 and an Analog-to-Digital (A/D) converter 430 that can convert the analog audio signals to digital audio signals. The digital audio signals can be represented in a series of image frames that correspond to a series of captured scenes. The audio recording device 400 can further include a digital processor that can conduct processing operations on the audio signals. The audio processing operations can be specified by predetermined criteria set by the manufacturer or by the user of the audio recording device 400.

The audio signal (in digital or analog format) can be transferred to a recording circuit 440 that is in electronic communications with a temporary memory buffer 450 and a semi-permanent data storage 460 via a system control unit 470. A host interface 480 is in electronic communication with the system control unit 470. The host interface 480 is used to connect the device to a host computer and is used to transfer the audio clips from the semi-permanent memory to the host computer. Examples of the actual host interface that could be used include, but are not limited to, USB or IEEE1394 (sometimes referred to as FireWire). The system control unit 470 allows transmitting the video data stored on the temporary memory buffer 450 and the semi-permanent data storage 460 to be transmitted to external devices. A digital-to-analog converter 490 can be connected with system control unit 470 that can receive digital audio data from the temporary memory buffer 450 and the permanent data storage 460. The analog audio signal output by the D/A converter can be sent to a speaker 495 for playing the audio signal to a listener.

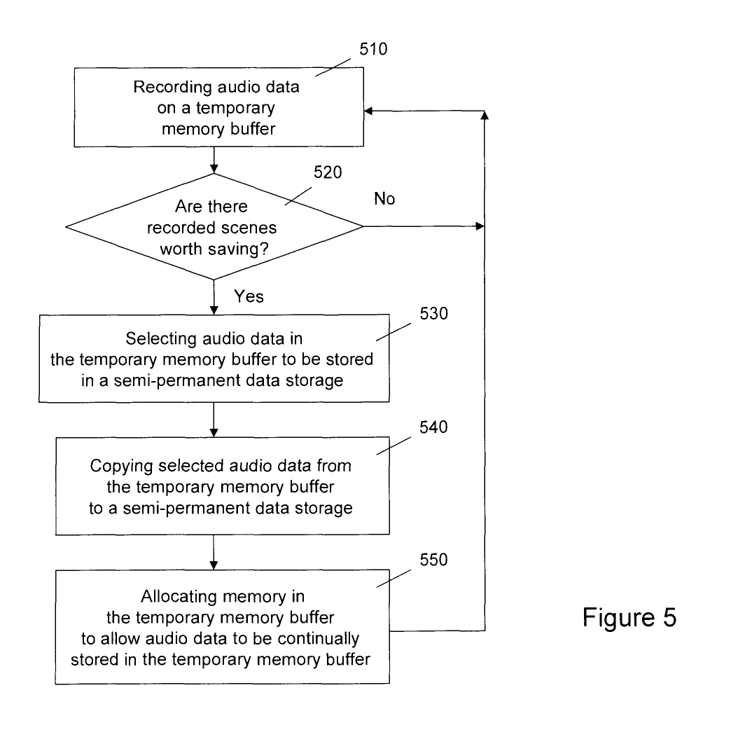

As shown in FIG. 5 and similar to the previous description about video recording device 100 in relation to FIGS. 3A and 3B, the audio recording device 400 allows audio data produced by a microphone 410 and an A/D converter 430 to be stored in a temporary memory buffer 450 (step 510). The user can determine if the audio data stored in the temporary memory buffer 450 is worthwhile saving (step 520). The audio signals stored in the temporary memory buffer 450 can be selected (step 530) and copied to a semi-permanent data storage 460 (step 540) if some audio signal worth saving has be recorded. A portion of the memory can be allocated in the temporary memory buffer 450 to allow smooth copying of the audio data from the temporary memory buffer 450 to the semi-permanent data storage 460 while audio data is continually recorded in the temporary memory buffer 450. The arrangement allows a user to save historically recorded and audio signals without unnecessarily recording too much uninteresting audio data and filling up the memories in the audio device.

The temporary memory buffer 450 and the semi-permanent data storage 460 can be detached and replaced. Examples of the temporary memory buffer 450 include a random access memory (RAM), dynamic random access memory (DRAM), static random access memory (SRAM), electrically erasable programmable read-only memory (EEPROM) such as a flash memory, and so on. Examples of the semi-permanent data storage 460 can include EEPROM (flash memories, memory sticks and memory cards), magnetic tapes, hard drives, etc. Because audio data size tend to be smaller, similar types of storage devices can used for the temporary memory buffer 450 and the semi-permanent data storage 460.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for video recording, comprising:
producing a first video data by an image sensor in a video recording device;
storing the first video data in a temporary memory buffer in the video recording device;
selecting at least a portion of the first video data in a semi-permanent data storage; and
copying the selected portion of the first video data from the temporary memory buffer to the semi-permanent data storage in the video recording device.

2. The method of claim 1, wherein the semi-permanent data storage is selected from the group of a magnetic tape, a recordable disk, a hard drive, a DVD-R, and a CD-R.

3. The method of claim 1, wherein the temporary memory buffer is selected from the group of random access memory (RAM), dynamic random access memory (DRAM), static random access memory (SRAM), EEPROM, and a flash memory.

4. The method of claim 1, further comprising:
writing the most recent portion of the first video data over the oldest portion of the first video data in the temporary memory buffer.

5. The method of claim 1, wherein the first video data is more than the capacity of the temporary memory buffer.

6. The method of claim 1, wherein the step of selecting comprises:
determining if at least a portion of the first video data is worth storing in a semi-permanent data storage; and
if at least a portion of the first video data is determined to be worth storing in a semi-permanent data storage, selecting at least the portion of the first video data.

7. The method of claim 1, further comprising:
producing a second video data by the image sensor; and
storing the second video data in the temporary memory buffer in the video recording device while the selected portion of the first video data is copied from the temporary memory buffer to the semi-permanent data storage in the video recording device.

8. The method of claim 1, further comprising:
producing a second video data by an image sensor in a video recording device; and
storing the second video data in the semi-permanent data storage without storing the second video data in the temporary memory buffer.

9. A method for audio recording, comprising:
producing a first audio data by a micro phone in an audio recording device;
storing the first audio data in a temporary memory buffer in the audio recording device;
selecting at least a portion of the first audio data in a semi-permanent data storage; and
copying the selected portion of the first audio data from the temporary memory buffer to the semi-permanent data storage in the audio recording device.

10. The method of claim 9, further comprising:
producing a second audio data by microphone in an audio recording device; and
storing the second audio data in the semi-permanent data storage without storing the second audio data in the temporary memory buffer.

11. The method of claim 9, further comprising:
writing the most recent portion of the first audio data over the oldest portion of the first audio data in the temporary memory buffer.

12. The method of claim 9, wherein the temporary memory buffer is selected from the group of random access memory (RAM), dynamic random access memory (DRAM), static random access memory (SRAM), EEPROM, and a flash memory.

13. The method of claim 9, wherein the step of selecting comprises:
determining if at least a portion of the first audio data is worth storing in a semi-permanent data storage; and
if at least a portion of the first audio data is determined to be worth storing in a semi-permanent data storage, selecting at least the portion of the first audio data.

14. A video recording device, comprising:
an image sensor configured to produce a first video data and a second video data; and
a recording system in electronic communication with the image sensor, wherein the recording system is configured to store the first video data in a temporary memory buffer in a first video recording mode and to store the second video data in a semi-permanent data storage in a second video recording mode, wherein at least a portion of the first video data is configured to be copied from the temporary memory buffer to the semi-permanent data storage.

15. The video recording device of claim 14, wherein the semi-permanent data storage is selected from the group of a magnetic tape, a recordable disk, a hard drive, a DVD-R, and a CD-R.

16. The video recording device of claim 14, wherein the temporary memory buffer is selected from the group of random access memory (RAM), dynamic random access memory (DRAM), static random access memory (SRAM), EEPROM, and a flash memory.

17. The video recording device of claim 14, wherein at least one of the semi-permanent data storage and the temporary memory buffer is configured to be removed from the video recording device and inserted into the video recording device such that the one of the semi-permanent data storage and the temporary memory buffer is in electronic communication with the recording system.

18. The video recording device of claim 14, wherein the temporary memory buffer comprises a circular buffer that allows the recording system to write the most recent portion of the first video data over the oldest portion of the first video data in the temporary memory buffer.

19. The video recording device of claim 14, further comprising a user interface that allows a user to select at least a portion of the first video data to be copied to the semi-permanent data storage.

20. The video recording device of claim 14, wherein the temporary memory buffer comprises a data pointer configured to indicate the current recording location in which the next video data is to be written in the temporary memory buffer.
